(19) United States
(12) Patent Application Publication
(10) Pub. No.: US 2023/0098980 A1
(43) Pub. Date: Mar. 30, 2023

(54) TERMINAL INSERTION DEVICE

(71) Applicant: YAZAKI CORPORATION, Tokyo (JP)

(72) Inventors: Hajime NAGANO, Makinohara-shi (JP); Kazuhiko TAKADA, Makinohara-shi (JP); Mamoru ARAKI, Makinohara-shi (JP)

(73) Assignee: YAZAKI CORPORATION, Tokyo (JP)

(21) Appl. No.: 17/951,635

(22) Filed: Sep. 23, 2022

(30) Foreign Application Priority Data
Sep. 27, 2021 (JP) 2021-157110

(51) Int. Cl. H01R 43/20

(52) U.S. Cl. CPC H01R 43/20

(57) ABSTRACT

A terminal insertion device inserts a terminal connected to an electric wire into a cavity of a housing. The terminal insertion device includes a rear chuck portion to grip the electric wire, a front chuck portion to grip the electric wire at a position closer to the terminal than is the rear chuck portion, the front chuck portion being movable toward and away from the rear chuck portion along an extending direction of the electric wire, a driving mechanism to advance and retreat the rear chuck portion and the front chuck portion relative to the housing, and a control part to control the rear chuck portion, the front chuck portion, and the drive mechanism. The control unit causes the terminal insertion device to execute an electric wire gripping operation, a sliding operation, an insertion operation, a switching operation and a reinsertion operation.

### CROSS-REFERENCE TO RELATED APPLICATION

The present application claims priority to Japanese Patent Application No. 2021-157110 filed on Sep. 27, 2021, the entire content of which is incorporated herein by reference.

### TECHNICAL FIELD

The presently disclosed subject matter relates to a terminal insertion device.

### BACKGROUND

An insertion device for a terminal with an electric wire according to a related technique includes a terminal clamping portion that clamps a terminal portion, a terminal clamping portion reciprocating unit, and an electric wire clamping portion. The terminal clamping portion reciprocating unit and the electric wire clamping portion are provided on a movable frame (for example, JP2005-142031A).

In this insertion device, a terminal of the terminal with an electric wire is clamped by the terminal clamping portion, and an electric wire portion close to the terminal is clamped by the electric wire clamping portion. In this state, the movable frame is advanced to temporarily insert the terminal into a terminal accommodating chamber of a connector housing. Thereafter, the terminal clamping portion is retracted obliquely rearward and outward, the movable frame is advanced, the electric wire portion clamped by the electric wire clamping portion is pushed in, and the terminal is fully inserted into the terminal accommodating chamber.

In the above-described insertion device, when the terminal clamping portion clamps the terminal, the terminal may be deformed or a posture of the terminal may be lost, and smooth insertion into the terminal accommodating chamber of the connector housing may not be achieved.

Also, since the electric wire is likely to buckle when the electric wire portion clamped by the electric wire clamping portion is pushed in after the terminal clamping portion has been retracted, it is necessary to increase a dimension of the clamping portion, which is clamped by the electric wire clamping portion, of the electric wire in a longitudinal direction, which leads to an increase in a size of the device. In particular, in recent years, there has been an increasing demand for an electric wire having a smaller electric wire diameter as an electric wire routed in a vehicle, and a problem that the electric wire is likely to buckle as the electric wire diameter becomes smaller is more likely to occur.

### SUMMARY

Illustrative aspects of the presently disclosed subject matter provide a terminal to insertion device capable of smoothly inserting a terminal into a cavity of a housing while achieving a reduction in size.

The above-described object of the presently disclosed subject matter is achieved by the following configuration.

According to an illustrative aspect of the presently disclosed subject matter, a terminal insertion device is configured to insert a terminal connected to an end portion of an electric wire into a cavity of a housing. The terminal insertion device includes a rear chuck portion configured to grip the electric wire, a front chuck portion configured to grip the electric wire at a position closer to the terminal than is the rear chuck portion, the front chuck portion being movable toward and away from the rear chuck portion along an extending direction of the electric wire, a driving mechanism configured to advance and retreat the rear chuck portion and the front chuck portion relative to the housing, and a control part configured to control the rear chuck portion, the front chuck portion, and the drive mechanism. The control unit causes the terminal insertion device to execute an electric wire gripping operation in which the electric wire is gripped by the front chuck portion and the rear chuck portion, a sliding operation in which the front chuck portion is slid toward the terminal while drawing the electric wire against the rear chuck portion, an insertion operation in which the front chuck portion and the rear chuck portion are simultaneously moved toward the housing to a position at which the front chuck portion does not contact the housing, thereby inserting the terminal into the cavity, a switching operation in which a position at which the electric wire is gripped by the front chuck portion is moved toward the rear chuck portion and a reinsertion operation in which the front chuck portion and the rear chuck portion are simultaneously moved toward the housing again to a position at which the front chuck portion does not contact the housing, thereby further inserting the terminal into the cavity.

Other aspects and advantages of the presently disclosed subject matter will be apparent from the following description, the drawings and the claims.

### BRIEF DESCRIPTION OF DRAWINGS

FIG. 1 is a schematic perspective view of a terminal insertion device according to the present embodiment;

FIG. 2 is a side view of a part of the terminal insertion device;

FIG. 3 is a side view of a part of a terminal insertion device showing a slide operation;

FIG. 4 is a side view of a part of the terminal insertion device showing an insertion operation;

FIG. 5 is a side view of a part of the terminal insertion device showing a switching operation;

FIG. 6 is a side view of a part of the terminal insertion device showing a reinsertion operation;

FIG. 7 is a side view of a part of the terminal insertion device showing the switching operation; and

FIG. 8 is a side view of a part of the terminal insertion device showing the reinsertion operation.

### DESCRIPTION OF EMBODIMENTS

A specific embodiment of the presently disclosed subject matter will be described below with reference to the drawings.

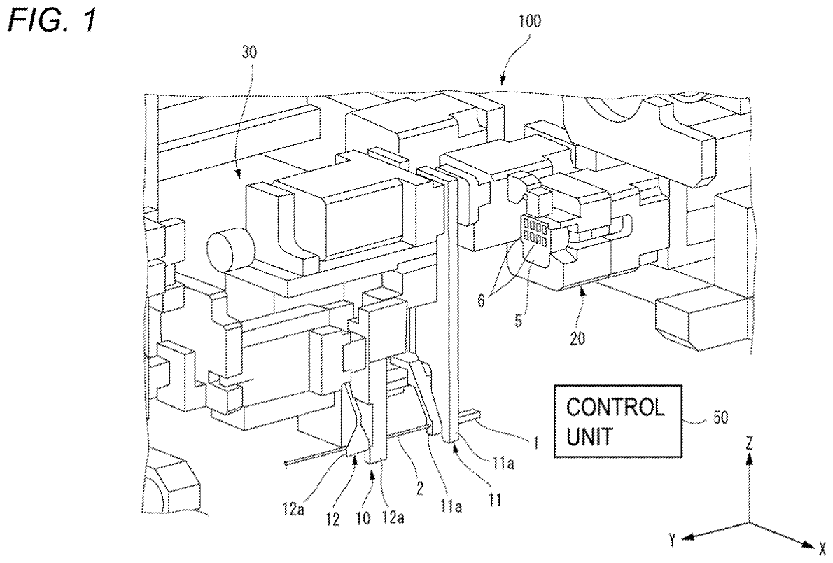

FIG. 1 is a schematic perspective view of a terminal insertion device according to the present embodiment.

As shown in FIG. 1, a terminal insertion device 100 according to the present embodiment includes a chuck 10 that grips an electric wire 2 connected to a terminal 1, a housing holder 20 that holds a housing 5, a driving mechanism 30 that moves the chuck 10, and a control unit 50. The terminal insertion device 100 is a device that inserts the terminal 1 into a cavity 6 of the housing 5 held by the housing holder 20. The terminal 1 is formed of a conductive metal material and is connected to an end portion of the electric wire 2. The terminal 1 is inserted into and accommodated in the cavity 6 of the housing 5.

The housing holder 20 holds the housing 5. The housing 5 is molded from a synthetic resin and has a plurality of cavities 6 for accommodating the terminal 1. The housing holder 20 grips the housing 5 such that an opening on a rear portion side of each of the plurality of cavities 6 faces a chuck 10 side.

The driving mechanism 30 moves the chuck 10 in a horizontal plane (an X direction and a Y direction) and moves the chuck 10 in an upper-lower direction (a Z direction). The driving mechanism 30 inserts, by moving the chuck 10 gripping the electric wire 2, the terminal 1 connected to the electric wire 2 into the cavity 6 of the housing 5 held by the housing holder 20.

The control unit 50 is connected to the chuck 10, the housing holder 20, and the driving mechanism 30, and is configured to control the chuck 10, the housing holder 20, and a driving unit of the drive mechanism 30.

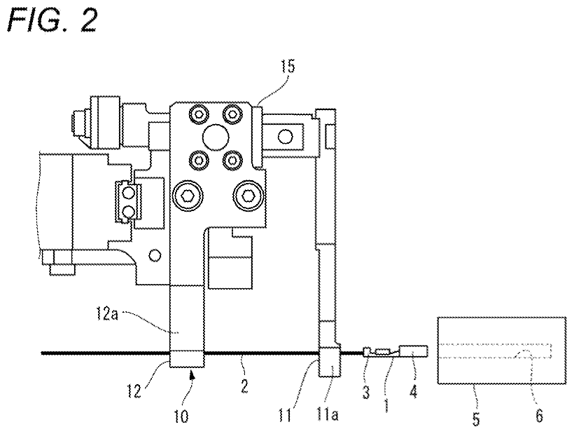

FIG. 2 is a side view of a part of the terminal insertion device. As shown in FIG. 2, the chuck 10 includes a front chuck portion 11 and a rear chuck portion 12. In the chuck 10, the front chuck portion 11 and the rear chuck portion 12 grip the electric wire 2 connected to the terminal 1. The front chuck portion 11 includes a pair of gripping claws 11a, and clamps and grips the electric wire 2 by the gripping claws 11a. The rear chuck portion 12 includes a pair of gripping claws 12a, and clamps and grips the electric wire 2 by the gripping claws 12a. The front chuck portion 11 grips the electric wire 2 at a position that is closer to the terminal 1 than is the rear chuck portion 12. The chuck 10 includes a driving unit such as an actuator 15. The actuator 15 advances and retreats the front chuck portion 11 relative to the rear chuck portion 12.

The terminal 1 includes an electric wire connection portion 3 that is crimped and connected to the electric wire 2, and a rectangular tubular electric connection portion 4 that is provided on a distal end side which is a side opposite to a connection side with the electric wire 2. A tab (not shown) of a mating terminal is to be inserted into the terminal 1 from the distal end side with respect to the electric connection portion 4. Accordingly, the terminal 1 is electrically connected to the mating terminal.

Next, a case will be described in which the control unit 50 of the terminal insertion device 100 described above drives the chuck 10, the housing holder 20, and the driving mechanism 30 to insert the terminal 1 into the cavity 6 of the housing 5.

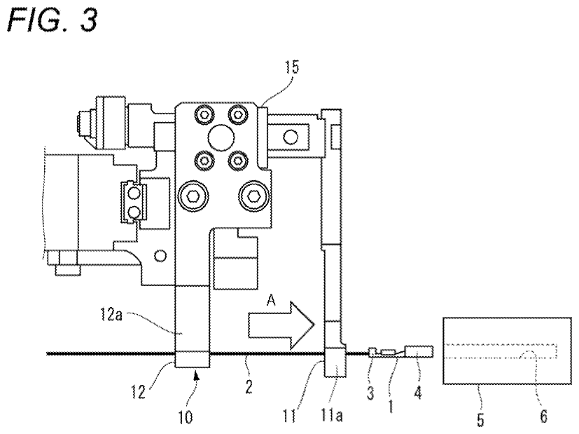

FIGS. 3 to 8 are side views of a part of the terminal insertion device showing operations for inserting the terminal into the cavity of the housing by the control unit.

First, the electric wire 2 connected to the terminal 1 is gripped by the front chuck portion 11 and the rear chuck portion 12 of the chuck 10. Further, the driving mechanism 30 is driven to move the chuck 10, and the terminal 1 connected to the end portion of the electric wire 2 is positioned behind the housing 5 held by the housing holder 20 (see FIG. 1).

As shown in FIG. 3, the actuator 15 slides the front chuck portion 11 toward the terminal 1 (in a direction of an arrow A in FIG. 3) while drawing the electric wire 2 against the rear chuck portion 12. By doing so, looseness of the electric wire 2 between the front chuck portion 11 and the rear chuck portion 12 is eliminated.

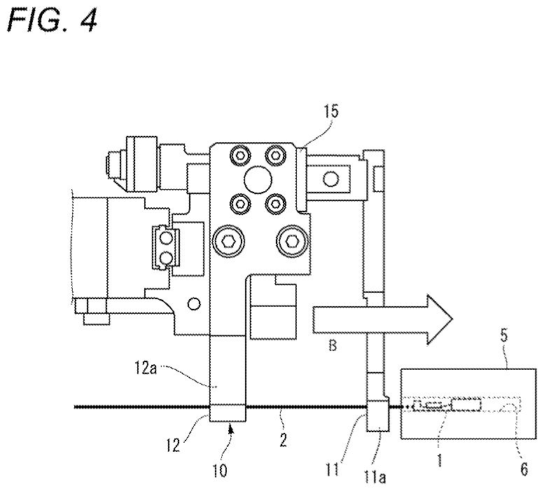

As shown in FIG. 4, the front chuck portion 11 and the rear chuck portion 12 of the chuck 10 are simultaneously moved toward the housing 5 (in a direction of an arrow B in FIG. 4). Accordingly, the terminal 1 in which the electric wire 2 is gripped by the front chuck portion 11 and the rear chuck portion 12 is inserted into the cavity 6 of the housing 5. At this time, the front chuck portion 11 is moved to a position at which the front chuck portion 11 does not come into contact with the housing 5.

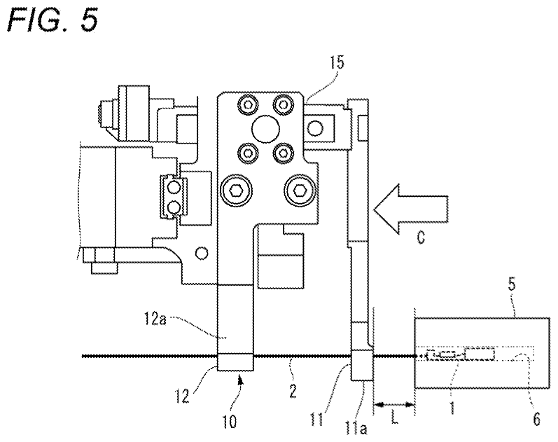

As shown in FIG. 5, the gripping of the electric wire 2 by the front chuck portion 11 is released, the front chuck portion 11 is slid toward the rear chuck portion 12 (in a direction of an arrow C in FIG. 5), and the electric wire 2 is gripped by the front chuck portion 11. Accordingly, a position at which the electric wire 2 is gripped by the front chuck portion 11 is moved toward the rear chuck portion 12.

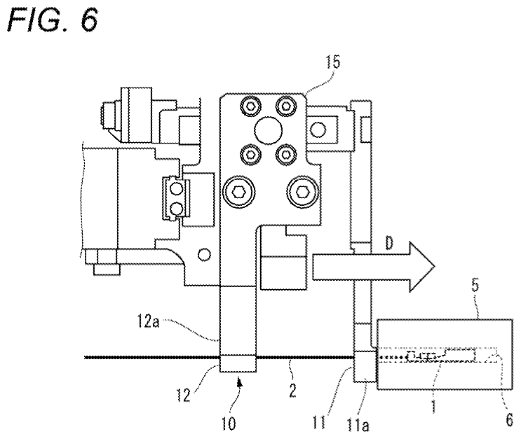

As shown in FIG. 6, the front chuck portion 11 and the rear chuck portion 12 of the chuck 10 are simultaneously moved toward the housing 5 (in a direction elan arrow D in FIG. 6). Accordingly, the terminal 1 in which the electric wire 2 is gripped by the front chuck portion 11 and the rear chuck portion 12 is further inserted into the cavity 6 of the housing 5. Also at this time, the front chuck portion 11 is moved to the position at which the front chuck portion 11 does not come into contact with the housing 5.

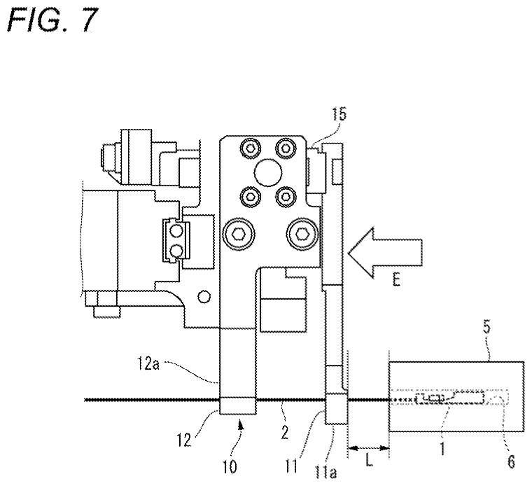

As shown in FIG. 7, the gripping of the electric wire 2 by the front chuck portion 11 is released, the front chuck portion 11 is slid toward the rear chuck portion 12 (in a direction of an arrow E in FIG. 7), and the electric wire 2 is gripped by the front chuck portion 11. Accordingly, a position at which the electric wire 2 is gripped by the front chuck portion 11 is moved toward the rear chuck portion 12.

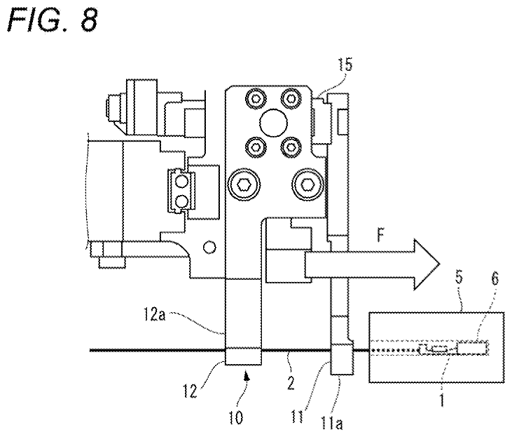

As shown in FIG. 8, the front chuck portion 11 and the rear chuck portion 12 of the chuck 10 are simultaneously moved toward the housing 5 (in a direction of an arrow F in FIG. 8). Accordingly, the terminal 1 in which the electric wire 2 is gripped by the front chuck portion 11 and the rear chuck portion 12 is further inserted into the cavity 6 of the housing 5. Also at this time, the front chuck portion 11 is moved to the position at which the front chuck portion 11 does not come into contact with the housing 5.

As the above-described operation is executed by the control unit 50, the terminal 1 connected to the end portion of the electric wire 2 can be smoothly inserted into the cavity 6 of the housing 5.

A movement distance L of the position at which the electric wire 2 is gripped by the front chuck portion 11 in the above-described switching operation (see FIGS. 5 and 7) is set to a position at which the electric wire 2 does not buckle in a state in which the front chuck portion 11 grips the electric wire 2. Accordingly, the buckling of the electric wire 2 during the reinsertion operation can be prevented, and the terminal 1 can be smoothly inserted into the cavity 6 of the housing 5.

As described above, the electric wire 2 is gripped by the rear chuck portion 12 and the front chuck portion 11, and the terminal 1 connected to the end portion of the electric wire 2 is inserted into the cavity 6 of the housing 5. Therefore, it is possible to prevent deformation of the terminal 1 and loss of the posture due to gripping the terminal 1. Also, in the case of handling an electric wire having a small diameter and being likely to buckle, the terminal can be inserted into the cavity of the housing without buckling the electric wire. Since the terminal 1 can be inserted into the cavity 6 while changing the gripping position of the electric wire 2 by moving the front chuck portion 11 toward and away from the rear chuck portion 12, it is possible to reduce a length of the rear chuck portion 12 and the front chuck portion 11 to reduce a size of the device, and to insert the terminal 1 efficiently by increasing an insertion amount of the terminal 1 in one insertion operation.

Also, by repeatedly performing tine switching operation and the reinsertion operation after the insertion operation, the insertion amount of the terminal 1 can be further increased, and the terminal 1 can be efficiently inserted.

While the presently disclosed subject matter has been described with reference to certain exemplary embodiments thereof, the scope of the presently disclosed subject matter is not limited to the exemplary embodiments described above, and it will be understood by those skilled in the art that various changes and modifications may be made therein without departing from the scope of the presently disclosed subject matter as defined by the appended claims.

According to an aspect of the embodiments described above, a terminal insertion device (100) is configured to insert a terminal (1) connected to an end portion of an electric wire (2) into a cavity (6) of a housing (5). The terminal insertion device (100) includes a rear chuck portion (12) configured to grip the electric wire (2), a front chuck portion (11) configured to alp the electric wire (2) at a position closer to the terminal (1) than is the rear chuck portion (12), the front chuck portion (11) being movable toward and away from the rear chuck portion (12) along an extending direction of the electric wire (2), a driving mechanism (30) configured to advance and retreat the rear chuck portion (12) and the front chuck portion (11) relative to the housing (5), and a control part (50) configured to control the rear chuck portion (12), the front chuck portion (11), and the drive mechanism (30). The control unit (50) causes the terminal insertion device (100) to execute an electric wire gripping operation in which the electric wire (2) is gripped by the front chuck portion (11) and the rear chuck portion (12), a sliding operation in which the front chuck portion (11) is slid toward the terminal (1) while drawing the electric wire (2) against the rear chuck portion (12), an insertion operation in which the front chuck portion (11) and the rear chuck portion (12) are simultaneously moved toward the housing (5) to a position at which the front chuck portion (11) does not contact the housing (5), thereby inserting the terminal (1) into the cavity (6), a switching operation in which a position at which the electric wire (2) is gripped by the front chuck portion (11) is moved toward the rear chuck portion (12) and a reinsertion operation in which the front chuck portion (11) and the rear chuck portion (12) are simultaneously moved toward the housing (5) again to a position at which the front chuck portion (11) does not contact the housing (5), thereby further inserting the terminal (1) into the cavity (6).

According to the terminal insertion device having an above-described configuration, the electric wire is gripped by the rear chuck portion and the front chuck portion, and the terminal connected to the end portion of the electric wire is inserted into the cavity of the housing. Therefore, it is possible to prevent deformation of the terminal and loss of the posture due to gripping the terminal. Also, in the case of handling an electric wire having a small diameter and being likely to buckle, the terminal can be inserted into the cavity of the housing without buckling the electric wire. Since the terminal can be inserted into the cavity while changing the gripping position of the electric wire by moving the front chuck portion toward and away from the rear chuck portion, it is possible to reduce a length of the rear chuck portion and the front chuck portion to reduce a size of the device, and to insert the terminal efficiently by increasing an insertion amount of the terminal in one insertion operation.

The control unit (50) may be configured to cause the terminal insertion device to repeatedly perform the switching operation and the reinsertion operation after the insertion operation.

With this configuration, by repeatedly performing the switching operation and the reinsertion operation after the insertion operation, the insertion amount of the terminal can be further increased, and the terminal can be efficiently inserted.

A movement distance (L) of the position at which the electric wire (2) is gripped by the front chuck portion (11) in the switching operation may be set such that the electric wire (2) does not buckle in a state in which the front chuck portion (11) grips the electric wire (2).

With this configuration, the buckling of the electric wire during the reinsertion operation can be prevented, and the terminal can be smoothly inserted into the cavity of the housing.

What is claimed is:

1. A terminal insertion device configured to insert a terminal connected to an end portion of an electric wire into a cavity of a housing, the terminal insertion device comprising:
a rear chuck portion configured to grip the electric wire;
a front chuck portion configured to grip the electric wire at a position closer to the terminal than is the rear chuck portion, the front chuck portion being movable toward and away from the rear chuck portion along an extending direction of the electric wire;
a driving mechanism configured to advance and retreat the rear chuck portion and the front chuck portion relative to the housing; and
a control part configured to control the rear chuck portion, the front chuck portion, and the drive mechanism,
wherein the control unit causes the terminal insertion device to execute:
an electric wire gripping operation in which the electric wire is gripped by the front chuck portion and the rear chuck portion;
a sliding operation in which the front chuck portion is slid toward the terminal while drawing the electric wire against the rear chuck portion;
an insertion operation in which the front chuck portion and the rear chuck portion are simultaneously moved toward the housing to a position at which the front chuck portion does not contact the housing, thereby inserting the terminal into the cavity;
a switching operation in which a position at which the electric wire is gripped by the front chuck portion is moved toward the rear chuck portion; and
a reinsertion operation in which the front chuck portion and the rear chuck portion are simultaneously moved toward the housing again to a position at which the front chuck portion does not contact the housing, thereby further inserting the terminal into the cavity.

2. The terminal insertion device according to claim 1,
wherein the control unit is configured to cause the terminal insertion device to repeatedly perform the switching operation and the reinsertion operation after the insertion operation.

3. The terminal insertion device according to claim 1,
wherein a movement distance of the position at which the electric wire is gripped by the front chuck portion in the switching operation is set such that the electric wire does not buckle in a state in which the front chuck portion grips the electric wire.
